(19) United States
(12) Patent Application Publication
(10) Pub. No.: US 2008/0024528 A1
(43) Pub. Date: Jan. 31, 2008

(54) APPARATUS AND METHOD FOR ADJUSTING COLOR CHARACTERISTICS OF DISPLAY SYSTEM USING DIFFRACTIVE OPTICAL MODULATOR

(75) Inventors: Kyu Bum Han, Yongin-si (KR); In Jae Yeo, Yongin-si (KR); Sun Ki Kim, Suwon (KR); Sang Kyeong Yun, Suwon (KR); Seung Won Ryu, Suwon (KR)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: SAMSUNG ELECTRO-MECHANICS CO., LTD., Suwon (KR)

(21) Appl. No.: 11/829,797

(22) Filed: Jul. 27, 2007

(30) Foreign Application Priority Data
Jul. 28, 2006 (KR) 1020060071501
Aug. 8, 2006 (KR) 10-2006-0074725
Aug. 21, 2006 (KR) 1020060078823

(51) Int. Cl. G09G 5/10

(52) U.S. Cl. 345/690

(57) ABSTRACT

The present invention relates to an apparatus and method for adjusting the color characteristics of a display system using a diffractive optical modulator, which can respond to a user's request to vary color characteristics so as to actively respond to variation in the brightness of external light, etc., and can adjust the overall brightness of an image while maintaining white balance without incurring the loss of gray levels.

### CROSS REFERENCE TO RELATED APPLICATION

This application claims the benefit of Korean Patent Application No. 10-2006-0071501, filed on Jul. 28, 2006, entitled “White Balance Controlling Method of Display System having Individual Red, Green and Blue Laser Diode Light Source”, Korean Patent Application No. 10-2006-74725, filed on Aug. 8, 2006, entitled “Apparatus for White Balance Controlling of Display System using Diffraction Modulation” and Korean Patent Application No. 10-2006-78823, filed on Aug. 21, 2006, entitled “Apparatus capable of adjusting the color characteristic for the display system using the diffractive optical modulator and method thereof”, which are hereby incorporated by reference in their entirety into this application.

### BACKGROUND OF THE INVENTION

1. Field of the Invention

The present invention relates generally to a display system using a diffractive optical modulator, and, more particularly, to an apparatus and method for adjusting the color characteristics of a display system using a diffractive optical modulator, which can respond to a user's request to change color characteristics so as to actively respond to variation in the brightness of external light, etc., and can adjust the overall brightness of an image while maintaining white balance without incurring the loss of gray levels.

2. Description of the Related Art

Recently, micromachining technology for manufacturing micro-optical parts, such as micromirrors, microlenses, and switches, micro-inertial sensors, micro-bio chips, and micro-wireless communication devices using semiconductor device manufacturing processes, has been developed.

Such a micromirror can be variously operated to undergo dynamic or static motions, such as vertical motion, rotational motion, and sliding motion. Vertical motion is applied to a phase corrector, a diffractor, etc., tilting motion is applied to a scanner, a switch, an optical signal distributor, an optical signal attenuator, a light source array, etc., and sliding motion is applied to an optical shield, a switch, an optical signal distributor, etc.

An example of such a micromirror is a reflective deformable grating optical modulator 10, as shown in FIG. 1, which is disclosed in U.S. Pat. No. 5,311,360, which was granted to Bloom et al. The optical modulator 10 includes reflective deformable ribbons 18, which have reflective surface parts 22 and which are suspended above a substrate 16 and spaced apart from each other at regular intervals. An insulating layer 11 is deposited on the silicon substrate 16. Next, a sacrificial silicon dioxide film 12 and a silicon nitride film 14 are subsequently deposited thereon.

The silicon nitride film 14 is patterned in the form of the ribbons 18, and part of the silicon dioxide film 12 is etched, so that the ribbons 18 are maintained on an oxide spacer layer by a silicon nitride frame 20.

In order to modulate light having a single wavelength of λ₀, the optical modulator 10 is designed such that the thickness of each of the ribbons 18 and the sacrificial silicon oxide film 12 is λ₀/4.

The amplitude of the grating of the optical modulator 10, which is limited to the vertical distance d between the reflective surfaces 22 on the ribbons 18 and the reflective surface of the substrate 16, is controlled by applying voltage between the ribbons 18 (the reflective surfaces 22 of the ribbons 18 functioning as a first electrode) and the substrate 16 (a conductive film 24 formed in the lower portion of the substrate 16 and adapted to function as a second electrode).

FIG. 2 is a sectional view showing a conventional recess-type thin film piezoelectric optical modulator.

Referring to FIG. 2, the conventional recess-type thin film piezoelectric optical modulator includes a silicon substrate 31 and elements 40.

In this case, a plurality of elements 40 may have a uniform width and may be aligned regularly, thus forming the recess-type thin film piezoelectric optical modulator. Alternatively, the elements 40 may have different widths and may be alternately aligned, thus forming the recess-type thin film piezoelectric optical modulator. Further, the elements 40 may be spaced apart from each other at regular intervals (almost the same as the width of the elements 40). In this case, the micromirror layer formed on the entire top surface of the silicon substrate 31 diffracts incident light by reflecting incident light.

The silicon substrate 31 includes a recess part to provide an air space to the elements 40. An insulating layer 32 is deposited on the top surface of the silicon substrate 31, and the ends of each element 40 are attached to both sides of the recess part.

The element 40 is formed in a bar shape, and the bottom surfaces of opposite ends thereof are respectively attached to opposite locations of the silicon substrate 31 deviating from the recess part, so that the center portion of the element 40 is arranged to be spaced apart from the recess part of the silicon substrate 31. Part of the element 40, disposed on the recess part of the silicon substrate 31, includes a vertically movable lower support 41.

The element 40 includes a lower electrode layer 42a stacked on the left end of the lower support 41 and adapted to provide piezoelectric voltage, a piezoelectric material layer 43a stacked on the lower electrode layer 42a and adapted to contract or expand when voltage is applied to both surfaces of the piezoelectric material layer 43a, thus generating a vertical driving force, and an upper electrode layer 44a stacked on the piezoelectric material layer 43a and adapted to provide piezoelectric voltage to the piezoelectric material layer 43a.

Further, the element 40 includes a lower electrode layer 42b stacked on the right end of the lower support 41 and adapted to provide piezoelectric voltage, a piezoelectric material layer 43b stacked on the lower electrode layer 42b and adapted to contract or expand when voltage is applied to both surfaces of the piezoelectric material layer 43b, thus generating a vertical driving force, and an upper electrode layer 44b stacked on the piezoelectric material layer 43b and adapted to provide piezoelectric voltage to the piezoelectric material layer 43b.

In a display device using such a diffractive optical modulator, the intensity of light projected on the screen is adjusted to be constant with respect to an input image.

However, in the display device using the diffractive optical modulator, the brightness of external light or the like may be changed at any time depending on the surrounding environment. Accordingly, variation between the intensity of diffracted light projected onto the screen and the brightness of external light occurs.

Further, a conventional display system using a diffractive optical modulator is problematic in that, since correction data required to adjust white balance is present in each address in memory, input image data is converted into digital data by an Analog/Digital (A/D) converter, and data required to adjust white balance is determined depending on Red (R), Green (G), and Blue (B) signals output from the A/D converter, and is output with the data included in the R, G, and B signals, so that gray levels for display may be lost.

### SUMMARY OF THE INVENTION

Accordingly, the present invention has been made keeping in mind the above problems occurring in the prior art, and the present invention is intended to provide an apparatus and method for adjusting the color characteristics of a display system using a diffractive optical modulator, which can respond to a user's request to change color characteristics so as to actively respond to variation in the brightness of external light, etc. in a display system using a diffractive optical modulator.

Further, the present invention is intended to provide an apparatus and method for adjusting the color characteristics of a display system using a diffractive optical modulator, which can control each individual light source, thus adjusting white balance without incurring the loss of gray levels.

In addition, the present invention is intended to provide an apparatus and method for adjusting the color characteristics of a display system using a diffractive optical modulator, which can adjust the overall brightness of an image while emphasizing a specific color based on a user's selection, or maintaining white balance without incurring the loss of gray levels.

In accordance with an aspect of the present invention, there is provided an apparatus for adjusting color characteristics of a display system using a diffractive optical modulator, comprising Red (R), Green (G) and Blue (B) light sources for emitting red light, green light, and blue light; a light source driver for driving the R, G, and B light sources; memory for storing individual light source power control indices for the R, G, and B light sources; an input unit for receiving a user command; and a light source output control unit for determining currents to be applied to respective R, G, and B light sources on a basis of the individual light source power control indices stored in the memory and the user command, and supplying the determined currents to the light source driver in order to adjust overall brightness of an image and a specific color.

In accordance with another aspect of the present invention, there is provided an apparatus for adjusting color characteristics of a display system using a diffractive optical modulator in an optical system, the optical system including the diffractive optical modulator having a light source system, a first reflection part, and a second reflection part spaced apart from the first reflection part such that a distance to the first reflection part is variable, the first and second reflection parts being implemented so that light reflected from the first reflection part and the second reflection part generates diffracted light and intensity of the diffracted light is determined on a basis of distance between the first and second reflection parts, the apparatus comprising an image signal input unit for receiving image data; an input unit for receiving a color characteristic change request from a user; an image output unit for outputting image data received from the image signal input unit and adjusting and outputting the distance between the first and second reflection parts of the diffractive optical modulator, which is required depending on image data, when the input unit receives the color characteristic change request from the user; and a panel driver for adjusting the distance between the first and second reflection parts of the diffractive optical modulator on a basis of the adjusted distance, output from the image output unit, when the image data is received from the image output unit.

In accordance with a further aspect of the present invention, there is provided a method of adjusting color characteristics of a display system using a diffractive optical modulator, comprising measuring currents at which maximum light intensities of Red (R), Green (G) and Blue (B) light sources are output, respectively, when maximum gray level data is output for each of the R, G, and B light sources; setting a light source that is outputting minimum light intensity, among the R, G, and B light sources, to a minimum light intensity output light source; setting a light intensity ratio of the R, G and B light sources according to an arbitrary target color temperature; and determining application currents, corresponding to output light intensities of respective light sources, on a basis of the light intensity ratio of the light sources and the minimum light intensity output light source.

In accordance with yet another aspect of the present invention, there is provided a method of adjusting color characteristics of a display system using a diffractive optical modulator in an optical system, the optical system including the diffractive optical modulator having a light source system, a first reflection part, and a second reflection part spaced apart from the first reflection part such that a distance to the first reflection part is variable, the first and second reflection parts being implemented so that light reflected from the first reflection part and the second reflection part generates diffracted light and intensity of the diffracted light is determined on a basis of the distance between the first and second reflection parts, the method comprising an image signal input unit receiving image data, and an image output unit outputting the image data, received by the image signal input unit, to a panel driver; the panel driver driving the diffractive optical modulator according to the received image data, thus displaying an image; the input unit receiving a color characteristic change request from a user; and the image output unit adjusting the distance between the first and second reflection parts of the diffractive optical modulator, which is required depending on the image data, and outputting the adjusted distance to the panel driver when the color characteristic change request is received from the user through the input unit.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing the construction of a conventional reflective deformable grating optical modulator;

FIG. 2 is a sectional view showing a conventional recess-type thin film piezoelectric optical modulator;

FIG. 3 is a block diagram showing a display system using a diffractive optical modulator according to an embodiment of the present invention;

FIG. 4 is a block diagram showing an embodiment of an apparatus for adjusting the color characteristics of the display system using the diffractive optical modulator of FIG. 3;

FIG. 5 is a flowchart showing a method of adjusting the white balance of the display system using the diffractive optical modulator of FIG. 3 according to an embodiment of the present invention;

FIG. 6 is a graph showing the amount of current at which the maximum intensity of light is output;

FIG. 7 is a block diagram showing another embodiment of an apparatus for adjusting the color characteristics of the display system using the diffractive optical modulator of FIG. 3;

FIG. 8A is a diagram showing the format of image data corresponding to a single frame composed of 480×640 pixels, and FIG. 8B is a diagram showing the format of input image data transposed from a lateral arrangement into a vertical arrangement;

FIG. 9 is a graph showing application voltages relative to the intensities of diffracted light in a diffractive optical modulator;

FIG. 10 is a graph showing light intensities relative to voltages applied to respective elements of the diffractive optical modulator;

FIG. 11 is a graph showing average light intensities relative to voltages applied to the diffractive optical modulator;

FIG. 12 is a diagram showing a correction table stored in an element-based correction data storage unit;

FIG. 13 is a graph showing a process for calculating element-based correction data;

FIG. 14 is a graph showing variation in light intensity caused by the adjustment of a lower electrode reference voltage; and

FIG. 15 is a flowchart showing a method of adjusting the color characteristics of a display system using a diffractive optical modulator according to another embodiment of the present invention.

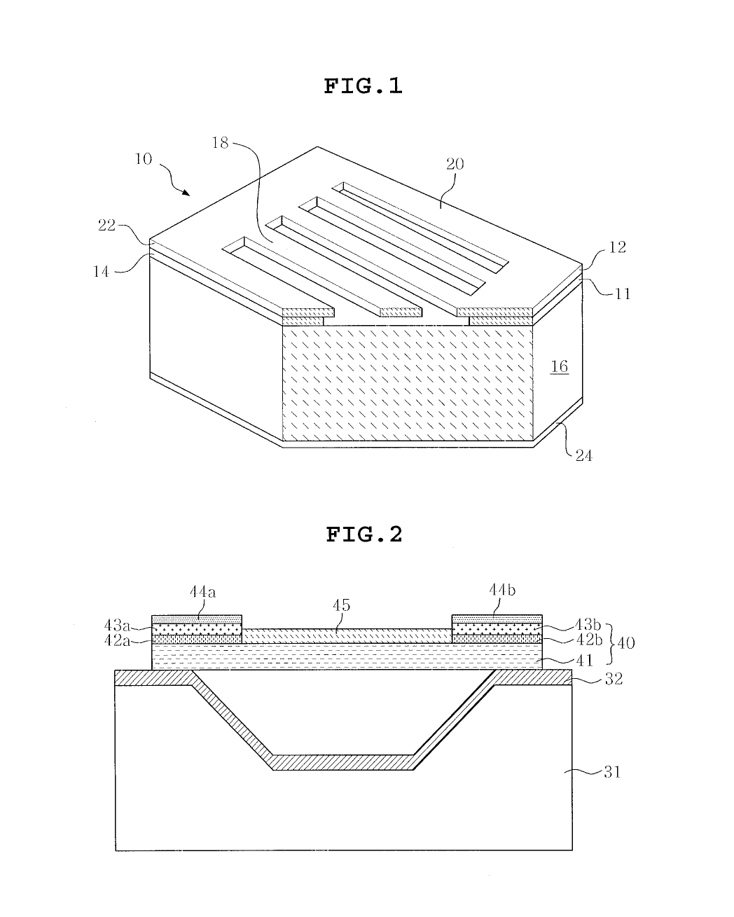

### DESCRIPTION OF THE PREFERRED EMBODIMENTS

Hereinafter, embodiments of the present invention will be described in detail with reference to the attached drawings.

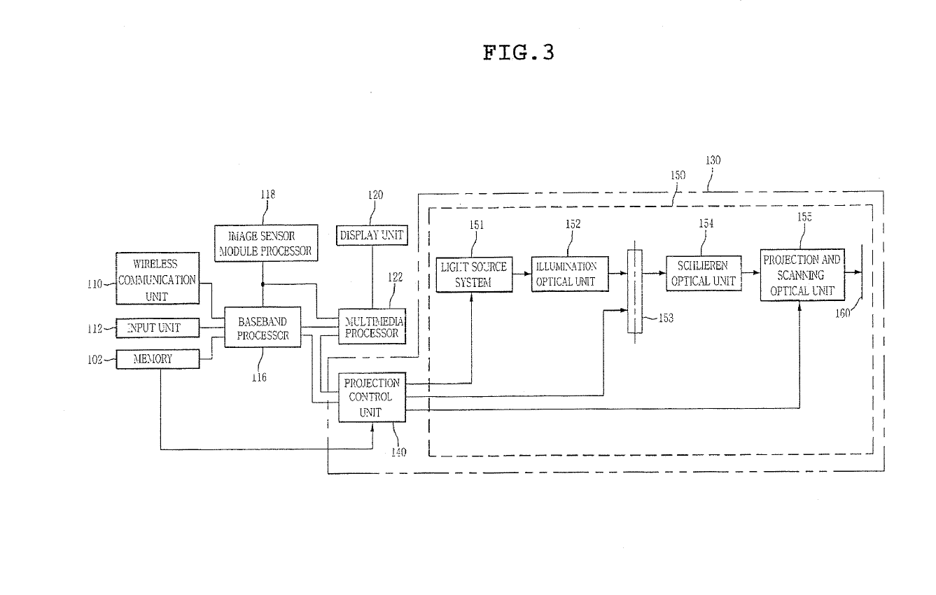

FIG. 3 is a block diagram showing a mobile display system using a diffractive optical modulator according to an embodiment of the present invention.

Referring to FIG. 3, the mobile display system using the diffractive optical modulator according to the embodiment of the present invention includes a wireless communication unit 110, an input unit 112, a baseband processor 116, an image sensor module processor 118, a display unit 120, an optical modulator projector 130, and memory 102.

The wireless communication unit 110 performs wireless communication with an external system.

The input unit 112 is implemented using at least one of a button, a keypad, a touch screen, and a remote controller, and is adapted to receive externally input information, that is, a user command.

The baseband processor 116 controls the wireless communication unit 110 so as to perform wireless communication with an external system, controls the image sensor module processor 118 so as to receive an image from a provided camera or the like, and controls the multimedia processor 122 so as to display the image on the display unit 120. Further, the baseband processor 116 controls the projection control unit 140 of the optical modulator projector 130 which is a display system using a diffractive optical modulator, in order to cause the image to be projected onto a screen 160.

In this case, the baseband processor 116 controls the wireless communication unit 110, the image sensor module processor 118, the multimedia processor 122, and the projection control unit 140 of the optical modulator projector 130, which is the display system using the diffractive optical modulator. The baseband processor 116 can be designated as a mobile device control unit for controlling mobile devices, such as Handheld Products (HHP), Personal Digital Assistants (PDAs), Portable Multimedia Players (PMPs), or notebook PCs, that is, a mobile terminal control system.

When an image is input from a provided camera or the like in response to a control command from the baseband processor 116, the image sensor module processor 118 processes the input image, and transmits the processed image data to the multimedia processor 122 and/or the baseband processor 116.

The display unit 120 displays the image data provided by the multimedia processor 122 on the screen.

The multimedia processor 122 processes the image data provided by the image sensor module processor 118 and the image data stored in the memory 102 as images suitable for the screen of the display unit 120 in response to a control command output from the baseband processor 116, and provides the processed images to the display unit 120.

Under the control of the baseband processor 116, the optical modulator projector 130 generates images based on the image data received from the multimedia processor 122 and/or the baseband processor 116 using the diffractive optical modulator, magnifies the generated images and projects the magnified images onto the screen 160. The baseband processor 116 provides the image data stored in the memory 102 to the optical modulator projector 130. Such an optical modulator projector 130 includes the projection control unit 140 and an optical modulation system 150.

The projection control unit 140 controls the optical modulation system 150 so that the optical modulation system 150 generates images based on the image data received from both the multimedia processor 122 and the baseband processor 116 in response to a control signal input from the baseband processor 116.

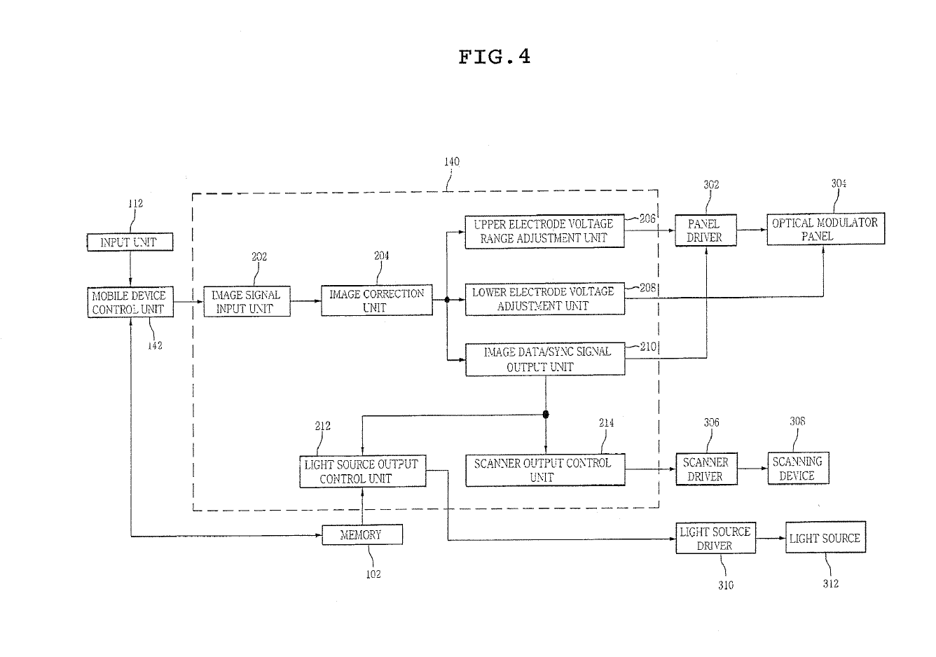

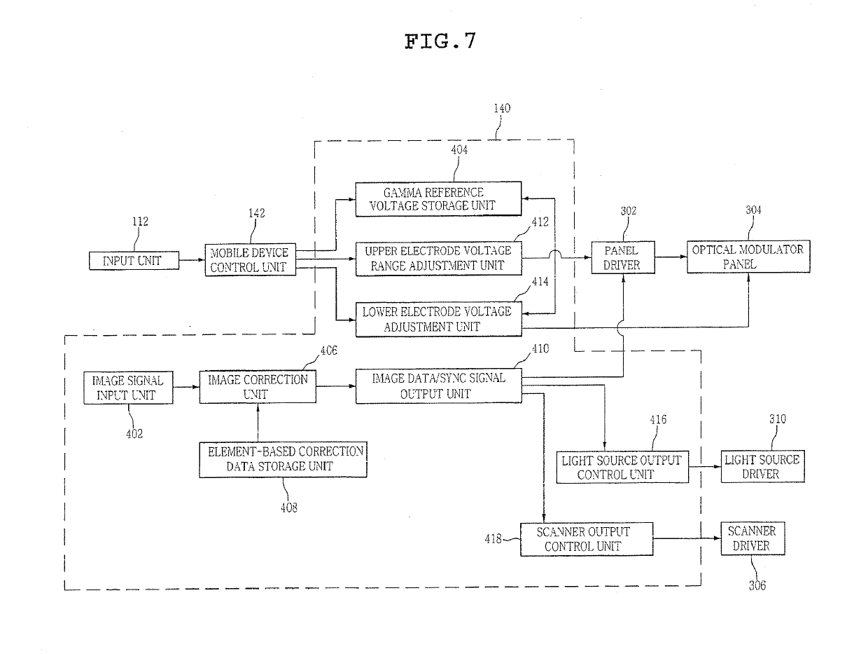

The projection control unit 140 may include an image signal input unit 202, an image correction unit 204, an upper electrode voltage range adjustment unit 206, a lower electrode voltage adjustment unit 208, an image data/synchronization signal output unit 210, a light source output control unit 210, and a scanner output control unit 214, as shown in FIG. 4, or may alternatively include an image signal input unit 402, a gamma reference voltage storage unit 404, an image correction unit 406, an element-based correction data storage unit 408, an image data/synchronization signal output unit 410, an upper electrode voltage range adjustment unit 412, a lower electrode voltage adjustment unit 414, a light source output control unit 416, and a scanner output control unit 418, as shown in FIG. 7. The construction of this projection control unit 140 will be described later.

The projection control unit 140 controls the white balance or color characteristics of the display system using the diffractive optical modulator, and thus it can be designated as a white balance adjustment apparatus or a color characteristic adjustment apparatus.

The optical modulation system 150 generates an image in response to the control signal input from the projection control unit 140, magnifies the generated image, and projects the magnified image onto the screen 160. Such an optical modulation system 150 includes a light source system 151, an illumination optical unit 152, a diffractive optical modulator 153, a Schlieren optical unit 154, and a projection and scanning optical unit 155.

The light source system 151 generates and emits Red (R) light, Green (G) light, and Blue (B) light in response to a light source switching signal provided by the projection control unit 140. The illumination optical unit 152 causes the light emitted from the light source system 151 to be incident on the diffractive optical modulator 153.

The diffractive optical modulator 153 diffracts light incident from the illumination optical unit 152 on the basis of an image data signal, a reference voltage, a lower electrode voltage, a vertical synchronization signal, and a horizontal synchronization signal, which are provided by the projection control unit 140, and thus generates an image (that is, light incident from the illumination optical unit 152 is diffracted to form diffracted light having a plurality of diffraction orders, and, at that time, diffracted light having any one diffraction order or several diffraction orders, among the diffracted light having the plurality of diffraction orders, is used to form a desired image).

The Schlieren optical unit 154 passes therethrough desired-order diffracted light, among the diffracted light having the plurality of diffraction orders generated by the diffractive optical modulator 153.

The projection and scanning optical unit 155 projects the image generated by the diffracted light passed through the Schlieren optical unit 154 onto the screen 160.

The memory 102 stores data such as image data, and control index values for respective R, G, and B light sources. In this case, the control index values are set by off-line tests using the following method.

First, the wavelengths of respective R, G, and B light sources and an arbitrary target color temperature (for example, 10000K) are set. In this case, depending on the set color temperature, the ratio of the intensities of light of respective R, G, and B light sources (for example, R:G:B=α:β:δ) is determined.

Further, in order to output maximum gray level data, the amount of current at which the maximum light intensity is output is measured while the amount of current supplied to each of the R, G, and B light sources is increased. Thereafter, a light source that is outputting the minimum light intensity, among the R, G, and B light sources, is determined. For example, in the case of R:G:B=a:b:c (where a>b>c, and a, b, and c denote output light intensities), the blue (B) light source is determined to be a light source that is outputting the minimum light intensity.

Accordingly, on the basis of the output light intensity of the B light source B_index_max, the output light intensity of the R light source R_index_max is set to c*α/δ, and the output light intensity of the G light source G_index_max is set to c*β/δ. In this case, the values of the set output light intensities for R, G, and B, that is, the values of R_index_max, G_index_max, and B_index_max, are stored in the memory 102.

Such memory 102 may include first memory for storing various types of data, such as image data, and second memory for storing control index values for R, G, and B light sources.

Further, the memory 102 stores therein individual light source power control index values R_ini, G_ini, and B_ini, based on the light intensity ratio of respective light sources (for example, R, G, and B light sources) in relation to set values for respective parts of the mobile device control unit, that is, a control command and initial white balance setting.

The individual light source power control index values are initial white balance set values required for setting white balance by offline tests before the display system using the diffractive optical modulator is delivered to the consumer, and are then set by the following method and stored in the memory 102.

First, respective light sources (R, G, and B light sources) output maximum gray level data (for example, 255 in the case of 8 bits, and 1024 in the case of 10 bits), and the amount of current, at which the maximum light intensity is output, is measured for each of the light sources. Thereafter the light source that is outputting the minimum light intensity is determined on the basis of the amount of current at which the maximum light intensity is output. For example, when the output light intensities of the R, G, and B light sources satisfy a:b:c (a>b>c>), the B light source is determined to be a light source that is outputting the minimum light intensity.

Further, an arbitrary target color temperature (for example, 31200 K) is set, that is, a target location on color coordinates, is determined, so that the light intensity ratio of respective R, G, and B light sources, corresponding to the target color temperature (for example, R:G:B=α:β:δ), is determined.

Accordingly, on the basis of the output light intensity of the B light source B_index_max, the output light intensity of the R light source R_index_max is set to c*α/δ, and the output light intensity of the G light source G_index_max is set to c*β/δ. In this case, the values of the set output light intensities for R, G, and B, that is, the values of R_index_max, G_index_max, and B_index_max, are stored in the memory 102.

In this case, the individual light source power control index values R_ini, G_ini, and B_ini are values required to set the initial white balance of mobile devices, such as HandHeld Products (HHP), Personal Digital Assistants (PDAs), Potable Multimedia Players (PMPs), or notebook PCs, and/or the display system using the diffractive optical modulator.

FIG. 4 is a block diagram showing an embodiment of the projection control unit of the display system using the diffractive optical modulator of FIG. 3.

Referring to FIG. 4, the projection control unit 140 includes an image signal input unit 202, an image correction unit 204, an upper electrode voltage range adjustment unit 206, a lower electrode voltage adjustment unit 208, an image data/synchronization signal output unit 210, a light source output control unit 212, and a scanner output control unit 214, and performs a function of interfacing with the mobile device control unit 142 and the memory 102. The mobile device control unit 142 denotes the baseband processor of FIG. 3.

The image signal input unit 202 receives image data signals RGB, a vertical synchronization signal Vsync, and a horizontal synchronization signal Hsync from the baseband processor 116, and outputs the image data signals RGB, the vertical synchronization signal Vsync, and the horizontal synchronization signal Hsync.

Further, the image signal input unit 202 receives image data signals from the multimedia processor 122 and outputs the image data signals to the image correction unit 204.

The image correction unit 204 performs data transposition on the laterally aligned image data signals, which are provided by the image signal input unit 202, into vertical image data signals, and buffers the vertical synchronization signal Vsync and the horizontal synchronization signal Hsync, which are provided by the image signal input unit 202.

Since such an image correction unit 204 laterally scans and displays a plurality of pixels, unlike the light modulation optical system 150 using the diffractive optical modulator 153, in which pixels are vertically arranged, data transposition must be performed.

Further, the image correction unit 204 divides N gamma reference voltages for R, G, and B light sources (N is determined by gray levels) into voltages for the R, G, and B light sources, and corrects transposed image data signals on the basis of the number of pixels (the number of pixels corresponding to vertical resolution, that is, the number of mirrors)*n pieces of correction data for each pixel (n varies according to the correction method) for each light source.

The upper electrode voltage range adjustment unit 206 adjusts the range of voltages to be supplied to the upper electrode of the optical modulator depending on the image data signals input from the image correction unit 204, and provides the adjusted voltage range to the panel driver 302, which drives the optical modulator panel 304. At this time, the optical modulator panel 304 and the panel driver 302 are components constituting the diffractive optical modulator 153.

The lower electrode voltage adjustment unit 208 adjusts the voltage that is supplied to the lower electrode of the optical modulator depending on the image data signals input from the image correction unit 204, and supplies the adjusted voltage to the optical modulator panel 304.

The image data/synchronization signal output unit 210 provides the image data signals RGB, the vertical synchronization signal Vsync, and the horizontal synchronization signal Hsync, which are input from the image correction unit 204, to the panel driver 302, the light source output control unit 212, and the scanner output control unit 214.

The light source output control unit 212 is supplied with control index values R_index_max, G_index_max, and B_index_max, corresponding to the output light intensities of the R, G, and B light sources, which are stored in the memory 102, and is adapted to determine application currents to be supplied to respective R, G, and B light sources, and to supply the application currents to the light source driver 310 for driving respective light sources on the basis of the vertical synchronization signal and the horizontal synchronization signal provided by the image data/synchronization signal output unit 210.

Further, the light source output control unit 212 supplies currents corresponding to the output light intensities R_index_max, G_index_max, and B_index_max, which are set to maintain individual light source power control index values R_ini, G_ini, and B_ini provided by the memory 102, that is, initial white balance, to the light source driver 310 for driving the R, G, and B light source.

In this case, the light source output control unit 212 supplies to the light source driver 310 the determined currents in synchronization with the vertical synchronization signal Vsync and the horizontal synchronization signal Hsync output from the image data/synchronization signal output unit 210.

Accordingly, the light source driver 310 drives respective light sources 312 depending on the currents supplied by the light source output control unit 212. As a result, the R, G, and B light sources emit light in such a way as to maintain white balance.

The light source output control unit 212 sets the currents to be supplied to respective light sources in response to the user commands input through the input unit 112 so that the overall brightness of the screen can be adjusted while the initial white balance is maintained, or so that a specific color can be emphasized or attenuated.

First, when user commands R_user, G_user, and B_user, required to adjust overall brightness after the initial white balance is maintained, are input through the input unit 112, the light source output control unit 212 sets the currents to be supplied to respective R, G, and B light sources on the basis of the individual light source power control index values R_ini, G_ini, and B_ini, provided by the memory 102, in response to the user commands R_user, G_user, and B_user, adds the currents, which have been set in response to the user commands R_user, G_user, and B_user, to the currents, which are based on the individual light source power control index values R_ini, G_ini, and B_ini, and supplies the resultant currents to the light source driver 310.

Since the user commands R_user, G_user, and B_user, input through the input unit 112, must be provided to adjust the overall brightness of the screen while maintaining the initial white balance, the ratio of the currents is determined on the basis of the ratio of the R, G, and B light sources when initial white balances are set, and the individual light source power control index values R_ini, G_ini, and B_ini stored in the memory 102.

In other words, the currents to be supplied to respective light sources in response to the user commands R_user, G_user, and B_user are determined in such a way that, in the case where the increments/decrements of the light intensities of respective light sources are equal to each other when unit index values increase/decrease, the ratio of the index increments/decrements is also set to r:g:b if the ratio of initial white balances and the ratio of index/brightness characteristic values for respective light sources, that is, the ratio of the light intensities of respective light sources when the initial white balances are set, are r:g:b. Accordingly, the currents to be supplied to respective R, G, and B light sources increase/decrease by the same increment/decrement. However, if the increments/decrements of light intensities differ between respective light sources when the unit index values increase/decrease, such differences are compensated for, and thus the increments/decrements of index values are determined.

Accordingly, the light source output control unit 212 supplies the currents R_ini+R_user, G_ini+G_user, and B_ini+B_user, which are obtained by adding the currents based on the user commands R_user, G_user, and B_user to the currents based on the individual light source power control index values R_ini, G_ini, and B_ini, to the light source driver 310. The light source driver 310 supplies the currents R_ini+R_user, G_ini+G_user, and B_ini+B_user to respective light sources 312, thus driving the light sources 312. As a result, the light sources 312 emit light so that the overall brightness can be adjusted while the initial white balances are maintained.

However, when a user command required to emphasize/attenuate a specific color (for example, red R) R_user is input through the input unit 112, the light source output control unit 212 supplies to the light source driver 310 specific color (for example, red R) emphasis/attenuation currents R_ini±R_user, G_ini, and B_ini, which are obtained by adding currents based on the individual light source power control index values R_ini, G_ini, and B_ini, provided by the memory 102, to current based on the input user command R_user. That is, only the current to be applied to any one of the R, G, and B light sources (for example, R light source) is changed, and the changed current is supplied to the light source driver 310.

Accordingly, the light source driver 310 supplies the currents R_ini±R_user, G_ini, and B_ini, which are required to emphasize/attenuate the red (R) color and are provided by the light source output control unit 212 to the light sources 312. The light sources 312 emit light, in which red (R) color is emphasized/attenuated, rather than white-balanced light, thus enabling an image in which a specific color (for example, red R) has been emphasized/attenuated to be displayed through the display unit 120 and the screen 160.

When the image is displayed, with specific color emphasized/attenuated in this way, there is an advantage in that even a person having difficulty in distinguishing between specific colors or all colors, such as a person with partial color blindness or color blindness, can realize an image using desired colors.

Finally, when the user inputs a reset command through the input unit 112, the light source output control unit 212 simultaneously changes the output light intensities R_ini, G_ini, and B_ini of respective R, G, and B light sources based on the individual light source power control index values R_ini, G_ini, and B_ini, which are provided by the memory 102, and supplies the output light intensities to the light source driver 310. In other words, the light source output control unit 212 simultaneously changes the currents R_ini, G_ini, and B_ini to be supplied to respective R, G, and B light sources to initial current values and supplies the initial current values to the light source driver 310 so that the initial white balances are maintained.

Therefore, the light source driver 310 converts the output light intensities of respective light sources, which are provided by the light source output control unit 212, into currents required to drive respective light sources, and supplies the currents to respective light sources 312. As a result, the R, G, and B light sources emit light so that white balance is maintained on the basis of the currents supplied by the light source driver 310.

The light sources 312 and the light source driver 112 are components constituting the light source system 151.

The scanner output control unit 214 provides the image data signals RGB provided by the image data/synchronization signal output unit 210 to a scanner driver 306 for driving the scanning device 308 in synchronization with the vertical synchronization signal Vsync and the horizontal synchronization signal Hsync.

Here, the scanning device 308 and the scanner driver 306 are components constituting the projection and scanning optical unit 155.

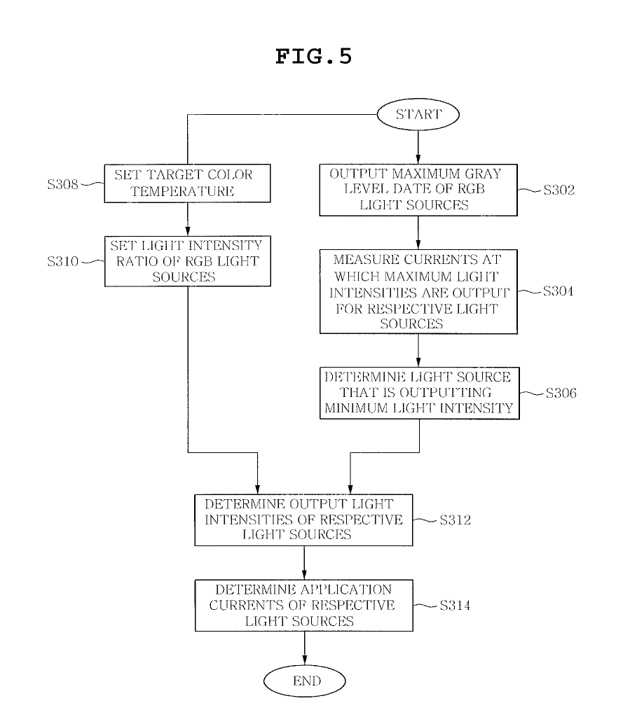

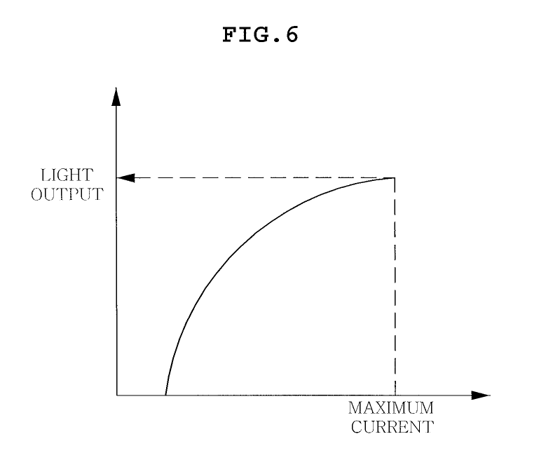

FIG. 5 is a flowchart showing a method of adjusting the white balance of the display system using the diffractive optical modulator of FIG. 3 according to an embodiment of the present invention, and FIG. 6 is a graph showing the measurement of the amount of current at which the maximum intensity of light is output.

Referring to FIGS. 5 and 6, in order to output maximum gray level data of respective R, G, and B light sources (255 in the case of 8 bits, and 1024 in the case of 10 bits), at step S302, the amount of current at which the maximum intensity of light is output is measured while the amount of current supplied to each of the R, G, and B light sources is increased, as shown in FIG. 6, at step S304.

Thereafter, the light source that is outputting the minimum light intensity, among the R, G, and B light sources, is determined using the measured value at step S306. For example, when the R light source outputs 1W, the G light source outputs 2W, and the B light source outputs 0.5 W, the B light source is determined to be the light source that is outputting the minimum light intensity.

Meanwhile, respective wavelengths of the R, G, and B light sources and an arbitrary target color temperature (for example, 10000 K) are set at step S308, and the light intensity ratio of the R, G, and B light sources (for example, R:G:B=α:β:δ) is determined on the basis of the set color temperature at step S310.

Thereafter, the output light intensities of the R, G, and B light sources are determined on the basis of the light intensity ratio of the R, G, and B light sources and the determined light source that is outputting the minimum light intensity at step S312.

In this case, the output light intensities of the R, G, and B light sources are determined in such a way that, on the basis of the output light intensity of the B light source B_index_max, the output light intensity of the R light source R_index_max is set to c*α/δ, and the output light intensity of the G light source G_index_max is set to c*β/δ.

When the output light intensities of the R, G, and B light sources are determined, application currents to be supplied to the R, G, and B light sources, respectively, are determined depending on the output light intensities of the R, G, and B light sources at step S314.

Thereafter, the determined application currents are supplied to the R, G, and B light sources, respectively.

This method of adjusting white balance is performed before a display system having individual R, G, and B laser diode light sources is delivered to the consumer.

As described above, the method of adjusting the color characteristics of the display system using the diffractive optical modulator according to the embodiment of the present invention determines a light source that is outputting the minimum light intensity using the amounts of current at which the maximum light intensities of respective R, G, and B light sources required to output maximum gray level data are output, determines the output light intensities of respective light sources on the basis of the determined minimum light intensity output light source and the light intensity ratio of respective light sources corresponding to an arbitrarily set target color temperature, and supplies currents corresponding to the determined output light intensities to respective light sources, thus adjusting white balance without incurring the loss of display gray levels.

Further, the apparatus for adjusting the color characteristics of the display system using the diffractive optical modulator according to the embodiment of the present invention adjusts initial white balance using application currents for respective light sources, corresponding to the output light intensities of respective light sources, on the basis of the light intensity ratio of the R, G, and B light sources corresponding to an arbitrary target color temperature and a light source that is outputting the minimum light intensity when the maximum gray level data is output, thus adjusting white balance without incurring the loss of gray levels.

Further, the apparatus for adjusting the color characteristics of the display system using the diffractive optical modulator according to the embodiment of the present invention simultaneously changes the output light intensities of respective R, G, and B light sources, thus adjusting the overall brightness of the screen while maintaining initial white balance in which loss in gray levels is not caused.

Further, the apparatus for adjusting the color characteristics of the display system using the diffractive optical modulator according to the embodiment of the present invention increases or decreases the light intensity of any one of the R, G, and B light sources by adjusting the output light intensity of any one of the R, G, and B light sources according to the user's selection, thus emphasizing or attenuating a specific color.

Accordingly, a person having difficulty in distinguishing between specific colors or all colors, such as a person with partial color blindness or color blindness, can realize an image using desired colors.

FIG. 7 is a block diagram showing another embodiment of the projection control unit of the display system using the diffractive optical modulator of FIG. 3.

Referring to FIG. 7, the projection control unit according to another embodiment of the present invention includes an image signal input unit 402, a gamma reference voltage storage unit 404, an image correction unit 406, an element-based correction data storage unit 408, an image data/synchronization signal output unit 410, an upper electrode voltage range adjustment unit 412, a lower electrode voltage adjustment unit 414, a light source output control unit 416, a scanner output control unit 418, a panel driver 302, a light source driver 310, and a scanner driver 306. In this case, since the gamma reference voltage storage unit 404, the image correction unit 406, the element-based correction data storage unit 408, the upper electrode voltage range adjustment unit 412, the lower electrode voltage adjustment unit 414, and the image data/synchronization signal output unit 410 output images, they can be designated as an image output unit. The upper electrode voltage range adjustment unit 412 and the lower electrode voltage adjustment unit 414 can be designated as a reference voltage output unit.

The image signal input unit 402 performs a function of interfacing with an optical modulation system 150 and a mobile device control system.

The image signal input unit 402 of the projection control unit 140 receives image data from the baseband processor 116 at the same time that it receives a vertical synchronization signal Vsync and a horizontal synchronization signal Hsync therefrom.

Further, the image correction unit 406 of the projection control unit 140 performs data transposition (or image pivoting) on laterally aligned image data into vertical data, thus converting laterally input image data into vertical image data and outputting the vertical image data.

The reason for performing data transposition in the image correction unit 406 is that the scan lines emitted from the optical modulator panel 304 are adapted to laterally scan and display image data because scanned diffracted light spots corresponding to a plurality of pixels (for example, 480 pixels when input image data has a 480*640 pixel size) are vertically arranged.

That is, standard image data is laterally aligned. However, since the optical modulator panel 304 is implemented so that a plurality of upper reflection parts is vertically arranged, it is adapted to display a plurality of pieces of image data while laterally scanning the image data.

Therefore, in order to form a single frame image composed of 480×640 pixels by scanning the scan lines using the optical modulator panel 304, 480 pieces of vertically arranged data are required.

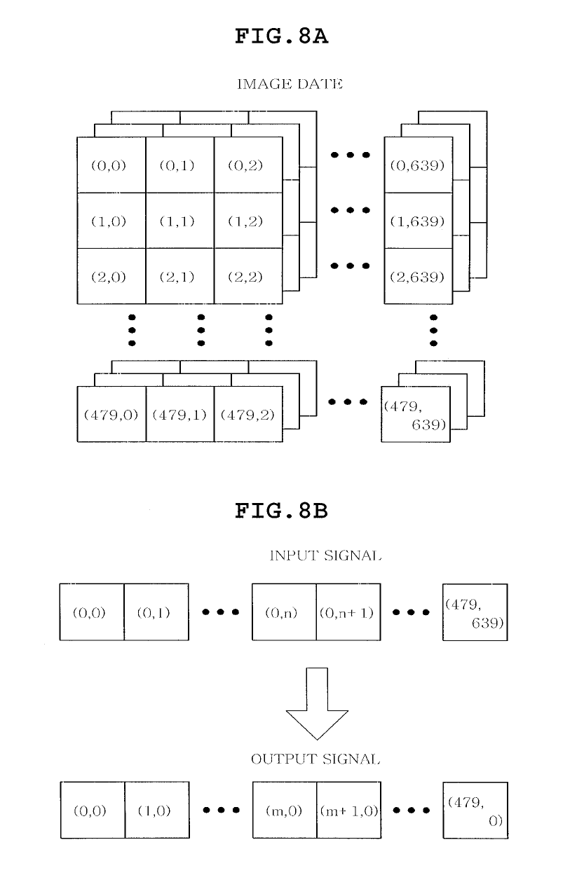

In other words, FIG. 8A illustrates the format of image data corresponding to a single frame composed of 480×640 pixels. The image data of FIG. 8A is externally input in a lateral direction, that is, in the sequence of (0,0),(0,0),(0, 2),(0,3), . . . .

However, 480 pieces of vertically arranged data are required in the optical modulator panel 304, so that the input data must be transposed from a lateral arrangement into a vertical arrangement.

Further, the image correction unit 406 sequentially outputs the transposed image data from a first column to a last column during a scanning period.

The image correction unit 406 performs correction on the image data on the basis of the element-based correction data table stored in the element-based correction data storage unit 408, and outputs the corrected data to the image data/synchronization signal output unit 410.

Meanwhile, the gamma reference voltage storage unit 404 stores an upper electrode (gamma) reference voltage and a lower electrode (gamma) reference voltage. The term “upper electrode (gamma) reference voltage” means an upper electrode reference voltage that is referred to when the panel driver 302 of the optical modulator panel 304 outputs application voltages corresponding to the gray levels of image data for respective elements, and the term “lower element reference voltage” means a voltage that is applied to the lower electrode of the optical modulator panel 304.

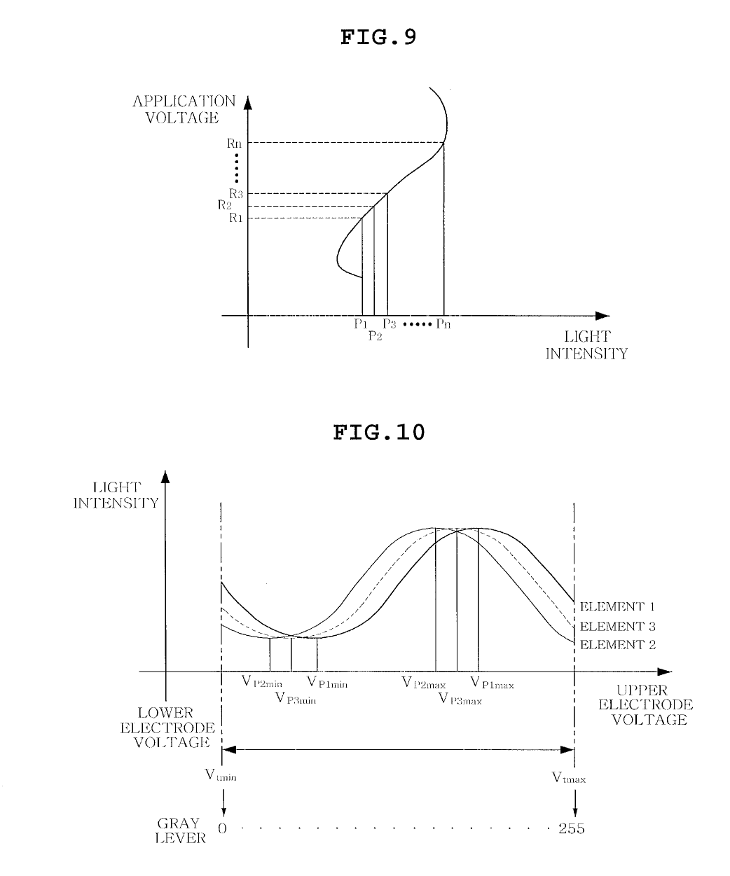

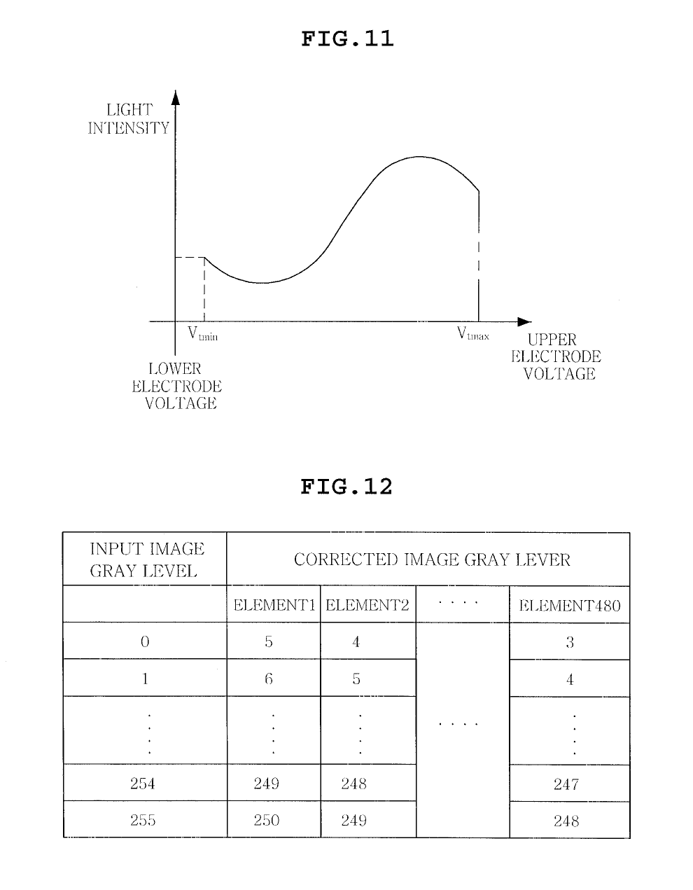

The reason for storing both the upper electrode reference voltage and the lower electrode reference voltage in the gamma reference voltage storage unit 404 and referring to them when the panel driver 302 of the optical modulator panel 304 outputs application voltages corresponding to gray levels is that the intensity of the diffracted light emitted from the optical modulator panel 304 exhibits the gamma characteristics of FIG. 9, in which it varies non-linearly according to the voltage level of application voltage, rather than linearly.

That is, referring to the light intensity hysteresis curve of FIG. 9, desired light intensity varies linearly, that is, intervals P1, P2, . . . , Pn are regular, whereas voltages to be applied R1, R2, . . . , Rn do not have regular intervals, but exhibit non-linearity. Accordingly, the upper electrode reference voltage and the lower electrode reference voltage are stored in the gamma reference voltage storage unit 404, thus allowing the panel driver 302 of the optical modulator panel 304 to refer to the voltages when outputting application voltages corresponding to gray levels.

Further, the upper electrode reference voltage and the lower electrode reference voltage, stored in the gamma reference voltage storage unit 404, are designated for each of the light sources. For example, R upper electrode reference voltage, ranging from R1 to Rn, is set for the R light source, G upper electrode reference voltage, ranging from G1 to Gn, is set for the G light source, and B upper electrode reference voltage, ranging from B1 to Bn, is set for the B light source.

In this case, the upper electrode reference voltage stored in the gamma reference voltage storage unit 404 can be implemented so that a minimum upper electrode reference voltage and a maximum upper electrode reference voltage for each light source are stored. That is, only the minimum and maximum values of the upper electrode reference voltage can be stored in the gamma reference voltage storage unit 404.

In this situation, when the gray level of image data is input from the image data/synchronization signal output unit 410, the panel driver 302 obtains an upper electrode voltage corresponding to the gray level with reference to the upper electrode reference voltage, provided by the upper electrode voltage range adjustment unit 412, so as to obtain an upper electrode voltage matching the gray level. At this time, the upper electrode voltage range adjustment unit 412 reads the upper electrode reference voltage stored in the gamma reference voltage storage unit 404 and outputs the read upper electrode reference voltage to the panel driver 302. Simultaneously with this operation, a lower electrode voltage is provided to the optical modulator panel 304 by the lower electrode voltage adjustment unit 414. That is, the lower electrode voltage adjustment unit 414 reads the lower electrode reference voltage stored in the gamma reference voltage storage unit 404 and provides the read voltage to the lower electrode of the optical modulator panel 304.

Accordingly, the optical modulator panel 304 is driven by the upper electrode voltage, provided by the panel driver 302, and the lower electrode voltage, provided by the lower electrode voltage adjustment unit 414, thus modulating incident light and forming diffracted light.

Meanwhile, the upper and lower electrode reference voltages are obtained in such a way that, when the optical modulator panel 304 is manufactured, it is repeatedly driven within a certain voltage range, and then element-based light intensity is obtained using a light intensity detector (for example, a photosensor, etc.), and, subsequently, an element-based light intensity hysteresis curve is created on the basis of the element-based light intensity, as shown in FIG. 9.

Examples of light intensity hysteresis curves for three different elements, obtained in this way, are shown in FIG. 10. In the case of element 1, voltage having the minimum light intensity is Vp1min, and voltage having the maximum light intensity is Vp1max. In the case of element 2, voltage having the minimum light intensity is Vp2min, and voltage having the maximum light intensity is Vp2max. In the case of element 3, voltage having the minimum light intensity is Vp3min and voltage having the maximum light intensity is Vp3max.

In this case, an experimenter can designate the range of upper electrode reference voltage to include both the lowest voltages required to detect minimum light intensities and the highest voltages required to detect maximum light intensities for all elements. For example, in FIG. 10, the range from Vtmin to Vtmax is designated.

When the experimenter inputs his or her selected upper electrode reference voltage to the gamma reference voltage storage unit 404 in this way, the input upper electrode reference voltage is stored in the gamma reference voltage storage unit 404.

Meanwhile, the element-based correction data stored in the element-based correction data storage unit 408 is referred to when the image correction unit 406 corrects the image data input from the image signal input unit 402 and generates corrected output image data, and can be configured in the form of the table shown in FIG. 12.

Referring to the correction data table of FIG. 12, it can be seen that externally input image gray levels (input image data) are present, and corrected image gray levels corresponding thereto (corrected output image data) are designated for respective elements.

For example, in the case of element 1, the correction data table is implemented so that, when input image gray levels are 0, 1, 254, and 255, corrected image gray levels are output as 5, 6, 249, and 250, respectively. In order to appreciate the reason why such element-based correction data is needed, the process of calculating the element-based correction data needs to be understood. In order to understand the calculation process, the operation of the panel driver 302 in the display application of the optical modulator panel 304 must be understood.

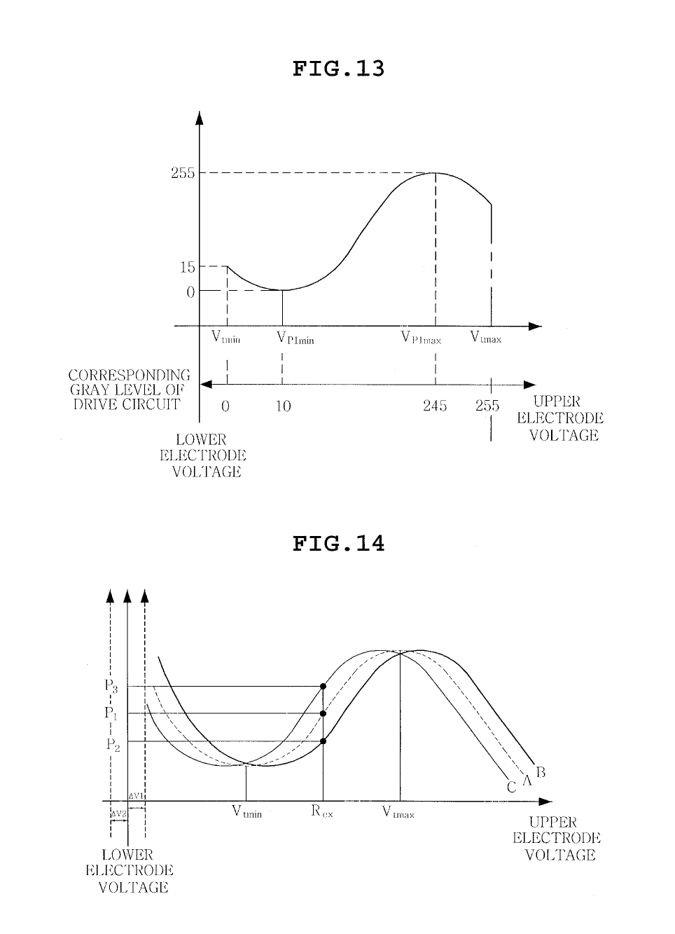

When a gray level is input, the panel driver 302 outputs an upper electrode voltage corresponding to the input gray level with reference to the upper electrode reference voltage, output from the upper electrode voltage range adjustment unit 412. For example, when the upper electrode reference voltage for the R light source ranges from R1 to Rn, the panel driver 302 outputs a drive voltage R1 when a gray level 0 is input, outputs a drive voltage Rn when a gray level 255 is input, and outputs a predetermined drive voltage when a value between 0 and 255 is input. However, as shown in FIG. 10, since the upper electrode reference voltage is set to a range including all minimum voltages and maximum voltages, rather than minimum and maximum voltages for respective elements, correction data for respective elements must be calculated on the contrary. This operation is described with reference to FIG. 13, which shows a light intensity hysteresis curve only for the element 1. In the case where an externally input gray level is, for example, 0, an output voltage is Vtmin if the gray level 0 is applied to the panel driver 302 without being corrected. At this time, the light intensity actually output by the element 1 is 15. Therefore, in order to overcome this disagreement, a gray level 10 corresponding to voltage Vp1min, at which the element 1 actually outputs a light intensity of 0, is output to the panel driver 302.

Consequently, the element-based correction data storage unit 408 configures corrected image gray levels, used to correct externally input image gray levels according to the above-described method, in the form of the table of FIG. 12, and stores the table.

Meanwhile, the image data/synchronization signal output unit 410 provides the image data, output from the image correction unit 406, to the panel driver 302.

Further, the image data/synchronization signal output unit 410 outputs the vertical synchronization signal and the horizontal synchronization signal received from the image correction unit 406.

The upper electrode voltage range adjustment unit 412 reads the upper electrode reference voltage, stored in the gamma reference voltage storage unit 404, outputs the upper electrode reference voltage to the panel driver 302, and adjusts and outputs the upper electrode reference voltage in response to a color characteristic change control signal when the color characteristic change control signal is input from the mobile device control unit 142.

That is, the upper electrode voltage range adjustment unit 412 reads the upper electrode reference voltage stored in the gamma reference voltage storage unit 404 and outputs the upper electrode reference voltage. At this time, when the color characteristic change control signal is input from the mobile device control unit 142, the upper electrode voltage range adjustment unit 412 corrects and outputs the upper electrode reference voltage in response to the color characteristic change control signal. The corrected value for the upper electrode reference voltage varies according to the correction request value of the color characteristic change control signal.

Further, the lower electrode voltage adjustment unit 414 reads the lower electrode reference voltage, stored in the gamma reference voltage storage unit 404, and outputs the read lower electrode reference voltage to the optical modulator panel 304. When a color characteristic change control signal is input from the mobile device control unit 142, the lower electrode voltage adjustment unit 414 adjusts and outputs the lower electrode reference voltage in response to the color characteristic change control signal.

That is, the lower electrode voltage adjustment unit 414 reads the lower electrode reference voltage, stored in the gamma reference voltage storage unit 404, and outputs the lower electrode reference voltage. At this time, when a color characteristic change control signal is input from the mobile device control unit 142, the lower electrode voltage adjustment unit 414 corrects and outputs the lower electrode reference voltage in response to the color characteristic change control signal. The corrected value for the lower electrode reference voltage varies according to the correction request value of the color characteristic change control signal.

In this way, when the upper electrode reference voltage, output from the upper electrode voltage range adjustment unit 412, is corrected in response to the color characteristic change control signal output from the mobile device control unit 142, or when the lower electrode reference voltage, output from the lower electrode voltage adjustment unit 414, is corrected in response to the color characteristic change control signal output from the mobile device control unit 142, the intensity of the diffracted light output from the optical modulator panel 304 is changed even if the same image data is input from the image data/synchronization signal output unit 410 to the panel driver 302, thus changing the color characteristics of the image disposed on the screen 160.

That is, when the upper electrode reference voltage output from the upper electrode voltage range adjustment unit 412 is adjusted, the upper electrode drive voltage of the optical modulator panel 304, generated by the panel driver 302, is changed even when the image correction unit 406 outputs the same image data to the image data/synchronization signal output unit 410. Accordingly, the intensity of diffracted light generated by the optical modulator panel 304 is changed, and, consequently, the color characteristics of the image displayed on the screen 160 are changed.

Further, when the lower electrode reference voltage output from the lower electrode voltage adjustment unit 414 is adjusted, the upper electrode drive voltage of the optical modulator panel 304, generated by the panel driver 302, is not changed when the image correction unit 406 outputs the same image data to the image data/synchronization signal output unit 410, but the lower electrode reference voltage applied to the optical modulator panel 304 is changed. Accordingly, the intensity of diffracted light, generated by the optical modulator panel 304, is changed, and, consequently, the color characteristics of the image displayed on the screen 160 are changed.

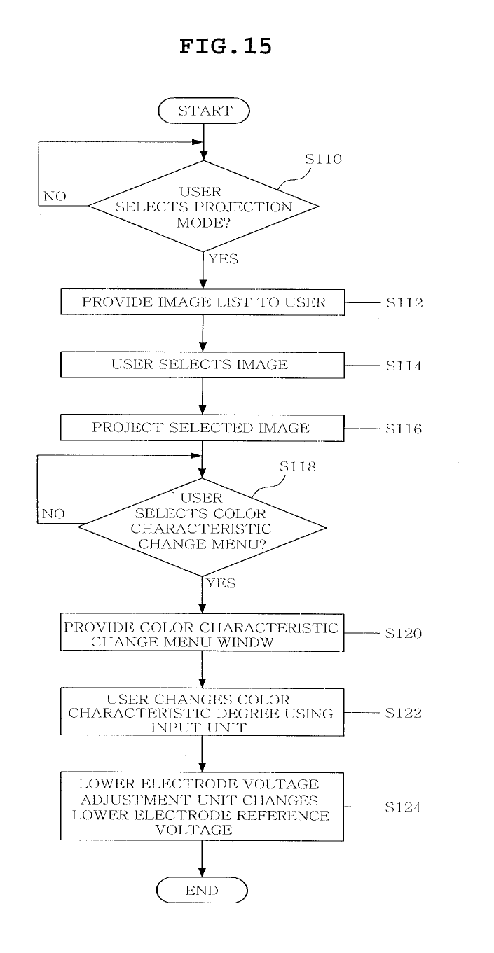

This operation is described by way of example, in which a lower electrode voltage is adjusted by the lower electrode voltage adjustment unit 414, with reference to FIG. 14. FIG. 14 is a graph showing application voltage versus output light intensity, which shows the minimum upper electrode voltage Vtmin, the maximum upper electrode voltage Vtmax, and lower electrode voltages, which are stored in the gamma reference voltage storage unit 404. As indicated by the solid line of FIG. 14, when the panel driver 302 outputs the upper electrode voltage, corresponding to a gray level input from the image data/synchronization signal output unit 410, with reference to the upper electrode reference voltage, which is input from the upper electrode voltage range adjustment unit 412, output light intensity can be obtained, as shown in the application voltage versus light intensity graph corresponding to the upper electrode voltage.

Meanwhile, when a correction value set in the lower electrode voltage adjustment unit 414 is ΔV1, the lower electrode voltage adjustment unit 414 adds a correction value to the lower electrode reference voltage stored in the gamma reference voltage storage unit 404 on the basis of the correction value, and outputs the resultant voltage to the optical modulator panel 304. In this case, since the upper electrode voltage is not changed, graph A shifts to graph B in the application voltage versus light intensity graph.

Further, when a correction value set in the lower electrode voltage adjustment unit 414 is −ΔV2, the lower electrode voltage adjustment unit 414 adds the correction value to the lower electrode reference voltage stored in the gamma reference voltage storage unit 404 (consequently, subtraction is performed), and outputs the resultant voltage when outputting a lower electrode voltage to the optical modulator panel 304. In this way, since the upper electrode voltage is not changed, graph A shifts to graph C in the application voltage versus light intensity graph.

In this way, the correction value of the lower electrode voltage adjustment unit 414 is changed, and thus the application voltage versus light intensity graph shifts from graph A to graph B, and from graph A to graph C. When the same image data is output from the image correction unit 406 to the image data/synchronization signal output unit 410, the upper electrode drive voltage of the optical modulator panel 304, generated by the panel driver 302, is not changed, but the lower electrode reference voltage to be applied to the optical modulator panel 304 is changed, and thus the drive voltage of the optical modulator panel 304 is changed. Accordingly, the intensity of the diffracted light is changed, and, consequently, the color characteristics of the image displayed on the screen 160 are changed.

For example, when the panel driver 302 receives a specific gray level from the image data/synchronization signal output unit 410, and outputs a voltage value Rex to the optical modulator panel 304 with reference to the upper electrode reference voltage, input from the upper electrode voltage range adjustment unit 412, according to the gray level, the intensity of the diffracted light emitted from the corresponding element of the optical modulator panel 304 becomes P1 if a low electrode reference voltage, which is not corrected, is first output to the lower electrode voltage adjustment unit 414.

However, when the correction value set in the lower electrode voltage adjustment unit 414 is adjusted to ΔV1, the upper electrode drive voltage of the optical modulator panel 304, generated by the panel driver 302, is not changed when the same image data is output from the image correction unit 406 to the image data/synchronization signal output unit 410, but the reference value of the lower electrode, provided by the lower electrode voltage adjustment unit 414 to the optical modulator panel 304, is changed by ΔV1 (that is, the application voltage versus light intensity output curve of FIG. 14 shifts from graph A to graph B). Accordingly, the intensity of light generated by the corresponding element of the optical modulator panel 304 is changed to P2, so that light intensity is decreased, and, as a result, the color characteristics of the screen 160 are changed.

Further, when the correction value set in the lower electrode voltage adjustment unit 414 is adjusted to −ΔV2, the upper electrode drive voltage of the diffractive optical modulator panel 304, generated by the panel driver 302, is not changed when the same image data is output from the image correction unit 406 to the image data/synchronization signal output unit 410, but the reference voltage of the lower electrode, provided by the lower electrode voltage adjustment unit 414 to the optical modulator panel 304, is changed by ΔV2 (that is, the application voltage versus light intensity output curve of FIG. 14 shifts from graph A to graph C). Accordingly, the intensity of light generated by the corresponding element of the optical modulator panel 304 is P3, so that light intensity is increased, and, as a result, the color characteristics of the screen 160 are changed.

Meanwhile, when a vertical synchronization signal and a horizontal synchronization signal are input from the image data/synchronization signal output unit 410, the light source output control unit 416 causes the light source driver 310 to switch the light sources by controlling the light source driver 310.

Next, when a vertical synchronization signal and a horizontal synchronization signal are input from the image data/synchronization signal output unit 410, the scanner output control unit 418 causes the scanner driver 306 to drive the scanner (not shown) of the projection and scanning optical unit 155 by controlling the scanner driver 306.

Further, when image data (gray level) is input from the image data/synchronization signal output unit 410, the panel driver 302 generates the upper electrode drive voltage corresponding to the gray level, with reference to the upper electrode reference voltage provided by the upper electrode voltage range adjustment unit 412, and outputs the drive voltage to the optical modulator panel 304.

Further, the lower electrode voltage adjustment unit 414 reads the lower electrode reference voltage, stored in the gamma reference voltage storage unit 404, and outputs the lower electrode reference voltage. At this time, when a color characteristic change control signal is input from the mobile device control unit 142, the lower electrode voltage adjustment unit 414 adjusts the lower electrode reference voltage in response to the color characteristic change control signal and outputs the adjusted lower electrode reference voltage to the optical modulator panel 304.

Meanwhile, the optical modulation system 150 includes a light source system 151 for generating and emitting R, G, and B light, an illumination optical unit 152 for causing the light emitted from the light source system 152 to be incident on the optical modulator panel 304, the optical modulator panel 304 for diffracting the light incident from the illumination optical unit 152 and generating an image (that is, the illumination optical unit 152 diffracts incident light to form diffracted light having a plurality of diffraction orders, and, at this time, diffracted light having any one diffraction order or several diffraction orders, among the diffracted light having the plurality of diffraction orders, is used to form a desired image), a Schlieren optical unit 154 for passing desired-order diffracted light therethrough, among the diffracted light having the plurality of diffraction orders generated by the optical modulator panel 304, and a projection and scanning optical unit 155 for projecting the image generated by the diffracted light, passed through the Schlieren optical unit 154, onto the screen 160.

Hereinafter, the operation of a mobile terminal including an optical modulation projector having the color characteristic adjustment apparatus according to an embodiment of the present invention is described with reference to FIGS. 3, 7 and 15.

First, the baseband processor 116 determines whether the user selects a projection mode, in which an image is magnified and projected onto the screen, using the input unit 112, at step S110. When it is determined that the user has selected the projection mode, the baseband processor 116 provides a projection mode window corresponding to the projection mode, and provides an image list to allow the user to select an image desired to be projected onto the screen 160 from the image list at step S112.

When the user selects the image desired to be projected onto the screen 160 from the image list at step S114, the baseband processor 116 transmits the image data of the image selected by the user to the projection control unit 140.

The baseband processor 116 transmits a projection mode control signal to the projection control unit 140, thus allowing the projection control unit 140 to transmit a drive signal corresponding to input image data both to the light source system 151 and to the optical modulator panel 304.

That is, the image signal input unit 402 of the projection control unit 140 receives the image data from the baseband processor 116 while receiving a vertical synchronization signal Vsync and a horizontal synchronization signal Hsync therefrom.

The image correction unit 406 of the projection control unit 140 performs data transposition on laterally aligned image data into vertical image data, thus converting laterally input image data into vertical image data and outputting the vertical image data.

The image correction unit 406 sequentially reads the transposed image data from the first column to the last column and outputs the image data during a scanning period.

In this case, the image correction unit 406 performs correction on the image data, input from the image signal input unit 204, on the basis of the element-based correction data table stored in the element-based correction data storage unit 408, and outputs the corrected data to the image data/synchronization signal output unit 410.

Then, when image data (gray level) is input from the image data/synchronization signal output unit 410, the panel driver 302 receives an upper electrode reference voltage from the upper electrode voltage range adjustment unit 412 and outputs the upper electrode drive voltage corresponding to the gray level to the optical modulator panel 304 with reference to the upper electrode reference voltage.

Accordingly, the optical modulator panel 304 is driven by the upper electrode drive voltage and outputs scan lines, each containing part of an image and each composed of a plurality of scanned diffracted light spots, and the projection and scanning optical unit 155 scans the scan lines onto the screen 160, thus generating images at step S116.

Meanwhile, the baseband processor 116 determines whether the user has selected a color characteristics change menu at step S118. If it is determined that the user has selected the color characteristic change menu, the baseband processor 116 provides a color characteristic change menu window at step S120. In this case, the menu window provided by the baseband processor 116 to the user is provided with a color characteristic degree increase button and a color characteristic degree decrease button. The user presses a required button to increase or decrease the corresponding color characteristic degree, and then presses a confirm button at step S122.

Then, in the case of the increase/decrease in the degree of the color characteristics, the baseband processor 116 transmits a lower electrode reference voltage increase/decrease control signal to the lower electrode voltage adjustment unit 414 of the projection control unit 140 (of course, an upper electrode voltage may be adjusted, wherein the adjustment of the range of the upper electrode voltage is requested from the upper electrode voltage range adjustment unit 412).

Accordingly, the correction value for the lower electrode voltage adjustment unit 414 is increased/decreased, so that the lower electrode reference voltage provided to the optical modulator panel 304 is increased/decreased depending on the correction value, and thus color characteristics are changed at step S124.

Here, the method of changing the reference voltage of the lower electrode has been described, but it will be apparent that the reference voltage of the upper electrode can alternatively be changed.

As described above, the present invention is advantageous in that it determines a minimum light intensity output light source using the amounts of current, at which the maximum light intensities of respective light sources required to output maximum gray level data are output, determines the output light intensities of respective light sources on the basis of the determined minimum light intensity output light source and the light intensity ratio of respective light sources corresponding to an arbitrarily set target color temperature, and supplies currents corresponding to the determined output light intensities to respective light sources, thus adjusting white balance without incurring the loss of display gray levels.

Further, the present invention is advantageous in that it adjusts initial white balance using application currents for respective light sources, corresponding to the output light intensities of respective light sources, on the basis of the light intensity ratio of the R, G, and B light sources corresponding to an arbitrary target color temperature and a light source that is outputting the minimum light intensity when the maximum gray level data is output, thus adjusting white balance without incurring the loss of gray levels.

Further, the present invention is advantageous in that it simultaneously changes the output light intensities of respective R, G, and B light sources, thus adjusting the overall brightness of the screen while maintaining initial white balance without incurring the loss of gray levels.

Further, the present invention is advantageous in that it increases or decreases the light intensity of any one of the R, G, and B light sources by adjusting the output light intensity of any one of the R, G, and B light sources according to the user's selection, thus emphasizing or attenuating a specific color.

Accordingly, the present invention is advantageous in that even a person having difficulty in distinguishing between specific colors or all colors, such as a person with partial color blindness or color blindness, can realize an image using desired colors.

Further, the present invention can actively respond to variation in the brightness of external light or the like, and can respond to users' requests for variation in color characteristics.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An apparatus for adjusting color characteristics of a display system using a diffractive optical modulator, comprising:
Red (R), Green (G) and Blue (B) light sources for emitting red light, green light, and blue light;
a light source driver for driving the R, G, and B light sources;
memory for storing individual light source power control indices for the R, G, and B light sources;
an input unit for receiving a user command; and
a light source output control unit for determining currents to be applied to respective R, G, and B light sources on a basis of the individual light source power control indices stored in the memory and the user command, and supplying the determined currents to the light source driver in order to adjust overall brightness of an image and a specific color.

2. The apparatus according to claim 1, wherein the individual light source power control indices include output light intensities of respective R, G, and B light sources using a light intensity ratio of the light sources set according to an arbitrary target color temperature and a light source that is outputting a minimum light intensity when maximum gray level data is output.

3. The apparatus according to claim 1, wherein the input unit is implemented using at least one of a button, a touch screen, a keypad, and a remote controller.

4. The apparatus according to claim 1, wherein the light source output control unit is operated so that, when a user command for adjusting overall brightness is input to the input unit, the light source output control unit adds currents, which are based on the user command and have been determined on a basis of the light intensity ratio of the R, G, and B light sources, to currents, which are based on the individual light source power control indices, and supplies resultant currents to the light source driver.

5. The apparatus according to claim 1, wherein the light source output control unit is operated so that, when a user command for emphasizing or attenuating a red color is input to the input unit, the light source output control unit adds current of the red (R) light source, which is based on the user command, to currents, which are based on the individual light source power control indices, and supplies the resultant currents to the light source driver.

6. The apparatus according to claim 1, wherein the light source output control unit is operated so that, when a reset command is input to the input unit, the light source output control unit initializes currents to be applied to respective R, G, and B light sources to currents based on the individual light source power control indices stored in the memory.

7. An apparatus for adjusting color characteristics of a display system using a diffractive optical modulator in an optical system, the optical system including the diffractive optical modulator having a light source system, a first reflection part, and a second reflection part spaced apart from the first reflection part such that a distance to the first reflection part is variable, the first and second reflection parts being implemented so that light reflected from the first reflection part and the second reflection part generates diffracted light and intensity of the diffracted light is determined on a basis of distance between the first and second reflection parts, the apparatus comprising:
an image signal input unit for receiving image data;
an input unit for receiving a color characteristic change request from a user;
an image output unit for outputting image data received from the image signal input unit and adjusting and outputting the distance between the first and second reflection parts of the diffractive optical modulator, which is required depending on image data, when the input unit receives the color characteristic change request from the user; and
a panel driver for adjusting the distance between the first and second reflection parts of the diffractive optical modulator on a basis of the adjusted distance, output from the image output unit, when the image data is received from the image output unit.

8. The apparatus according to claim 7, wherein:
the diffractive optical modulator comprises a piezoelectric element including a lower electrode layer, a piezoelectric material layer, and an upper electrode layer in order to change the distance between the first and second reflection parts, and
the image output unit adjusts drive voltage values to be applied to the upper electrode layer and the lower electrode layer to change the distance between the first and second reflection parts of the diffractive optical modulator, which is required depending on image data, when the input unit receives the color characteristic change request from the user.

9. The apparatus according to claim 8, wherein the image output unit comprises:
an application voltage output unit for storing an upper electrode reference voltage and a lower electrode reference voltage to be applied to the diffractive optical modulator, outputting the upper electrode reference voltage to the panel driver, outputting the lower electrode reference voltage to the diffractive optical modulator, and adjusting and outputting the upper electrode reference voltage when the input unit receives the color characteristic change request from the user; and
an image correction unit for outputting image data received through the image signal input unit to the panel driver.

10. The apparatus according to claim 9, wherein the application voltage output unit comprises:
a gamma reference voltage storage unit for storing the upper electrode reference voltage to be applied to the upper electrode layer of the piezoelectric element of the diffractive optical modulator and the lower electrode reference voltage to be applied to the lower electrode layer; and
a reference voltage output unit for reading the upper electrode reference voltage and the lower electrode reference voltage stored in the gamma reference voltage storage unit, outputting the upper and lower electrode reference voltages, and adjusting and outputting the upper electrode reference voltage when the input unit receives the color characteristic change request from the user.

11. The apparatus according to claim 8, wherein the image output unit comprises:
an application voltage output unit for storing an upper electrode reference voltage and a lower electrode reference voltage to be applied to the diffractive optical modulator, outputting the upper electrode reference voltage to the panel driver, outputting the lower electrode reference voltage to the diffractive optical modulator, and adjusting and outputting the upper electrode reference voltage when the input unit receives the color characteristic change request from the user; and
an image correction unit for outputting image data received through the image signal input unit to the panel driver.

12. The apparatus according to claim 11, wherein the application voltage output unit comprises:
a gamma reference voltage storage unit for storing the upper electrode reference voltage to be applied to the upper electrode layer of the piezoelectric element of the diffractive optical modulator and the lower electrode reference voltage to be applied to the lower electrode layer; and
a reference voltage output unit for reading the upper electrode reference voltage and the lower electrode reference voltage stored in the gamma reference voltage storage unit, outputting the upper and lower electrode reference voltages, and adjusting and outputting the upper electrode reference voltage when the input unit receives the color characteristic change request from the user.

13. The apparatus according to claim 10, wherein the reference voltage output unit comprises:
an upper electrode voltage range adjustment unit for reading the upper electrode reference voltage stored in the gamma reference voltage storage unit and adjusting and outputting the upper electrode reference voltage when a color characteristic change control signal is input from the input unit; and
a lower electrode voltage adjustment unit for reading the lower electrode reference voltage stored in the gamma reference voltage storage unit, and adjusting and outputting the lower electrode reference voltage when a color characteristic change control signal is input from the input unit.

14. The apparatus according to claim 12, wherein the reference voltage output unit comprises:
an upper electrode voltage range adjustment unit for reading the upper electrode reference voltage stored in the gamma reference voltage storage unit, and adjusting and outputting the upper electrode reference voltage when a color characteristic change control signal is input from the input unit; and
a lower electrode voltage adjustment unit for reading the lower electrode reference voltage stored in the gamma reference voltage storage unit, and adjusting and outputting the lower electrode reference voltage when a color characteristic change control signal is input from the input unit.

15. A method of adjusting color characteristics of a display system using a diffractive optical modulator, comprising:
measuring currents at which maximum light intensities of Red (R), Green (G) and Blue (B) light sources are output, respectively, when maximum gray level data is output for each of the R, G, and B light sources;
setting a light source that is outputting minimum light intensity, among the R, G, and B light sources, to a minimum light intensity output light source;
setting a light intensity ratio of the R, G and B light sources according to an arbitrary target color temperature; and
determining application currents, corresponding to output light intensities of respective light sources, on a basis of the light intensity ratio of the light sources and the minimum light intensity output light source.

16. The method according to claim 15, further comprising determining currents to be applied to respective light sources and supplying the currents to the light sources after the output light intensities of respective light sources have been determined.

17. The method according to claim 15, wherein the measuring the currents is performed such that the maximum gray level is 255 when input image data is 8-bit data.

18. The method according to claim 15, wherein the measuring the currents is performed such that the maximum gray level is 1024 when the input image data is 10-bit data.

19. The method according to claim 15, wherein the measuring the currents is performed such that the maximum gray level is 255 when the input image data is 8-bit data.

20. The method according to claim 15, wherein the measuring the currents is performed such that the maximum gray level is 1024 when the input image data is 10-bit data.

21. A method of adjusting color characteristics of a display system using a diffractive optical modulator in an optical system, the optical system including the diffractive optical modulator having a light source system, a first reflection part, and a second reflection part spaced apart from the first reflection part such that a distance to the first reflection part is variable, the first and second reflection parts being implemented so that light reflected from the first reflection part and the second reflection part generates diffracted light and intensity of the diffracted light is determined on a basis of the distance between the first and second reflection parts, the method comprising:
an image signal input unit receiving image data, and an image output unit outputting the image data, received by the image signal input unit, to a panel driver;
the panel driver driving the diffractive optical modulator according to the received image data, thus displaying an image;
the input unit receiving a color characteristic change request from a user; and
the image output unit adjusting the distance between the first and second reflection parts of the diffractive optical modulator, which is required depending on the image data, and outputting the adjusted distance to the panel driver when the color characteristic change request is received from the user through the input unit.

22. The method according to claim 21, wherein:
the diffractive optical modulator comprises a piezoelectric element including a lower electrode layer, a piezoelectric material layer, and an upper electrode layer in order to change the distance between the first and second reflection parts, and
the image output unit adjusting the distance is performed such that the image output unit adjusts and outputs drive voltage values to be applied to the upper electrode layer and the lower electrode layer so as to change the distance between the first and second reflection parts of the diffractive optical modulator, which is required depending on image data, when the input unit receives the color characteristic change request from the user.

23. The method according to claim 22, wherein the image output unit adjusting the distance comprises:
a reference voltage output unit of the image output unit adjusting an upper electrode reference voltage stored in a gamma reference voltage storage unit when the input unit receives the color characteristic change request from the user; and
the reference voltage output unit outputting the adjusted upper electrode reference voltage and a lower electrode reference voltage.

24. The method according to claim 22, wherein the image output unit adjusting the distance comprises:
a reference voltage output unit of the image output unit adjusting a lower electrode reference voltage stored in a gamma reference voltage storage unit when the input unit receives the color characteristic change request from the user; and
the reference voltage output unit outputting an upper electrode reference voltage and the adjusted lower electrode reference voltage.
